(19) United States
(12) Patent Application Publication
(10) Pub. No.: US 2008/0135593 A1
(43) Pub. Date: Jun. 12, 2008

(54) Combined Booster Cushion and Bag

(76) Inventor: Maria Munther, Goteborg (SE)

Correspondence Address: HARNESS, DICKEY & PIERCE, P.L.C., P.O. BOX 8910, RESTON, VA, 20195, US

(21) Appl. No.: 11/578,725

(22) PCT Filed: Apr. 18, 2006
(86) PCT No.: PCT/SE05/00559

§ 371 Date: Aug. 9, 2007

(30) Foreign Application Priority Data
Apr. 19, 2004 (SE) 0400995-7

(51) Int. Cl. B60N 2/28; A45C 9/00; A45C 15/00; A45F 3/04; A45F 4/02

(52) U.S. Cl. 224/576; 297/188.2; 224/155

(57) ABSTRACT

A combined booster cushion and bag (1), comprising carrying means (5, 16), a storage member (2) and a booster cushion member (4) having a user-facing side (3). The storage member (2) is configured to be releasably joined to the user-facing side (3) of said booster cushion member (4). With a combined booster cushion and bag according to the present invention, the availability of the booster cushion is greatly increased, for example since the risk of leaving behind the booster cushion member is reduced. Thereby the safety of children and others travelling in a motor vehicle is improved.

### TECHNICAL FIELD OF THE INVENTION

The present invention relates to a combined booster cushion and bag, comprising carrying means, a storage member and a booster cushion member having a user-facing side.

The invention further relates to a booster cushion, comprising at least one compartment.

Moreover, the present invention relates to a storage member for attachment to a booster cushion.

### TECHNICAL BACKGROUND

Since the seat belts of a motor vehicle in general are adapted for use by adults, it is recommended and/or prescribed by law that children use child safety seats or booster cushions when travelling in a motor vehicle. The type of adapter seat is determined by the age and size of the child—a smaller child would use a child safety seat, and a larger child, for example aged 4-12, would use a booster cushion or similar.

Families with children usually have booster cushions in their cars so that these cushions can be used whenever one or more of the children travel in the car. For avoiding unnecessary risk of injury, however, it is important that a booster cushion is used at all times when a child in need of such a cushion travels in a motor vehicle and not only when travelling with the parents in the family car.

Various solutions have been suggested to enable a child to travel safely at all time, be it in the family car, in a taxi or in a school bus.

In DE 197 38 022, a combined booster cushion and school backpack is disclosed. The thus disclosed combined booster cushion and school backpack consists of a standard issue school backpack with a booster cushion attached thereto. A drawback of this arrangement is that the booster cushion may be left behind accidentally or on purpose. The latter may be the case since the combined bag is very bulky and appears difficult for a small child to manoeuvre.

### OBJECTS OF THE INVENTION

In view of the above-mentioned and other drawbacks of the prior art, a general object of the present invention is to provide an improved combined booster cushion and bag.

Another object of the invention is to enable children and others to travel more safely in motor vehicles.

### SUMMARY OF THE INVENTION

These and other objects are, according to a first aspect of the invention, achieved by a combined booster cushion and bag, comprising carrying means, a storage member and a booster cushion member having a user-facing side, wherein said storage member is configured to be releasably joined to the user-facing side of said booster cushion member.

“Carrying means” are means for carrying the combined booster cushion and bag. By “carrying means” should be understood any means suitable for carrying a storage container. Such means can, for example, be shoulder straps, a single strap, a handle or combinations thereof. Said carrying means can be arranged on said booster cushion member as well as on said storage member or on both of these.

By “user-facing side” should be understood the side facing the user when the booster cushion is used to sit on, preferably in a motor vehicle.

With a combined booster cushion and bag according to the present invention, the availability of the booster cushion is greatly increased, for example since the risk of leaving behind the booster cushion member is reduced. Thereby the safety of children and others travelling in a motor vehicle is improved.

According to one embodiment of the combined booster cushion and bag, said booster cushion member can comprise at least one compartment.

A “compartment” is here a space for storage. This space may be larger or smaller than the storage member also comprised in the combined booster cushion and bag of the invention.

By providing storage space in the form of one or several compartments in the booster cushion member, an additional incentive for not leaving the booster cushion member behind is given.

In another embodiment of the combined booster cushion and bag, said carrying means can be arranged on a vehicle seat-facing side of the booster cushion member.

By the “vehicle seat-facing side” should be understood the side of the booster cushion member facing the vehicle seat. The vehicle seat-facing side is positioned opposite the user-facing side as seen from the user-facing side.

Through the arrangement of the carrying means on the vehicle seat-facing side of the booster cushion member, the booster cushion member is more likely to be brought along. The safety of the user is thereby improved further.

The above-mentioned carrying means may preferably comprise shoulder straps.

The shoulder straps can be adjustable in length and in position on the booster cushion member. Said shoulder straps may, furthermore, be complemented by, for example, a handle arranged on the booster cushion member.

Furthermore, the booster cushion member according to the invention can comprise seat belt guides.

The seat belt of a motor vehicle can be adapted to the anatomy of a child or smaller person by seat belt guides on the booster cushion member. Thereby, the safety in the event of a collision is improved.

The seat belt guides can be formed as integral parts of the booster cushion member or as separate parts attached to the booster cushion member by the manufacturer.

Advantageously, the booster cushion member of the invention may further comprise closure means.

By “closure means” should be understood any means suitable for closing a storage compartment. Such means can, for example, be a zipper, a lid, a simple flap, a sliding door, a string for pursing a flexible portion of a compartment, etc.

Preferably, said closure means may be positioned on the backward facing side of the booster cushion member.

“Backward facing” here refers to the user of the booster cushion member when sitting on the booster cushion member in a motor vehicle.

By positioning the closure means on the backward facing side, or at least avoiding placing the closure means on the forward facing side, any content inside the booster cushion member is prevented from hitting the user's legs in the event of a strong deceleration or acceleration of the vehicle in which she/he is sitting.

The same advantageous effect is, of course, also obtained by positioning the closure means on the side(s) of the booster cushion member. Through a suitable construction of the closure means, a forward-facing closure means can naturally also prevent the contents of the booster cushion compartment from flying out in the event of a collision or similar.

According to an embodiment of the combined booster cushion and bag according to the invention, said storage member can comprise carrying means.

These storage member carrying means may be used to carry the storage member when detached from the booster cushion member or the combined structure when the storage member is joined to the booster cushion member.

Preferably, said storage member can be a bag, such as a backpack.

According to a second aspect of the invention, it is provided a booster cushion, comprising a user-supporting member, said user-supporting member being supported by side members which are interconnected by at least one stabilising member at least partly positioned below and distanced from said user-supporting member, said side members and at least one stabilising member forming a framed construction which is at least partly walled, in order to form at least one compartment.

By “framed construction” should be understood a construction in which the strength of the construction is mainly given by a frame or a framework of constructive elements.

Such a construction can be made light and strong, while still allowing for the formation of a compartment inside the booster cushion.

Through this booster cushion construction, a light and strong booster cushion can be realised. Particularly, a compartment can be formed inside the booster cushion without compromising the function of the booster cushion and thereby the safety of the person using it.

The user supporting member can, for example, be a hard shell or a soft material which has been stretched between the side members. Such a soft material could, for example be fabric.

“Fabric” should be understood as woven, non-woven material or similar. The framed construction can also be walled by other materials, such as plastic or paper-based materials.

The main purpose of the stabilising member is to provide the framed construction with added stability. A further purpose of the stabilising member is to help form at least one compartment inside the booster cushion. It should be understood that the stabilising member(s) can extend between the side members in parallel with or at an angle to the user-supporting member.

According to one embodiment, said booster cushion can comprise carrying means in order to facilitate bringing the booster cushion along at all times, especially when travelling in a vehicle, such as a school bus or a taxi.

Advantageously, said at least one stabilising member can comprise at least one strut, extending between said side members.

The above-mentioned carrying means can be arranged on said at least one stabilising member.

The carrying means, such as shoulder straps, handle, etc., can be positioned anywhere on any of the stabilising members.

Preferably, the above-mentioned carrying means can comprise shoulder straps.

The shoulder straps may be arranged so that either side or the booster cushion can be carried closest to the user's back.

According to one embodiment of the booster cushion according to the invention said side members may comprise seat belt guides.

Through the arrangement of seat belt guides on the side members, the seat belt of the vehicle can be guided so that it becomes correctly positioned for a child or small adult who might be using the booster cushion in a car, school bus or similar.

According to another embodiment, the booster cushion may comprise closure means, such as a lid.

Preferably, said closure means may be positioned on the backward facing side of the booster cushion member.

“Backward facing” here refers to the user of the booster cushion member when using the booster cushion member in a motor vehicle.

By positioning the closure means on the backward facing side, or at least avoiding placing the closure means on the forward facing side, any content inside the booster cushion member is prevented from hitting the user's legs in the event of a strong deceleration or acceleration of the vehicle in which she/he is sitting.

The same advantageous effect is, of course, also obtained by positioning the closure means on the side(s) of the booster cushion member. Through a suitable construction of the closure means, a forward-facing closure means can naturally also prevent the contents of the booster cushion compartment from flying out in the event of a collision or similar.

According to a further embodiment of the booster cushion according to the invention, the framed construction may be at least partly walled by fabric.

“Fabric” should be understood as woven, non-woven material or similar. The framed construction can also be walled by other materials, such as plastic or paper-based materials.

Preferably, the framed construction comprised in the booster cushion according to the invention can be at least partly manufactured using injection-moulding.

Injection moulding is a manufacturing method which may be suitable for at least a part of a booster cushion according to the invention. Especially, the side members are suited for manufacturing using this method. Alternative manufacturing methods include, for example, bending of metal tubes.

According to yet another embodiment, the user-supporting member, comprised in the booster cushion, may be formed to be lower under the seat of a user than under her/his legs and to have a curvature substantially following the curvature of the user's legs.

By forming the user-supporting member in this way, the user can be prevented from sliding under the seat belt in the event of a sudden acceleration or deceleration. The safety of the user is thus improved. Furthermore, the comfort of the user can be enhanced.

According to a further embodiment, a bag comprising a storage member and a booster cushion according to the invention is provided. The storage member may advantageously be releasably joined to the booster cushion.

A bag can thus be formed by combining a storage member with a booster cushion, comprising a user-supporting member, said user-supporting member being supported by side members which are interconnected by at least one stabilising member positioned below and distanced from said user-supporting member, said side members and at least one stabilising member forming a framed construction which is at least partly walled, in order to form at least one compartment.

This storage member may be positioned on either side of the booster cushion. The bag, comprising the booster cushion and the storage member, can be carried using either carrying means, such as shoulder straps or a handle, on the booster cushion or corresponding carrying means arranged on the storage member.

By “releasably joined” should be understood that the storage member can be detached after attachment. This can be carried out with various kinds of interconnection means, such as velcro, snap fasteners, zippers, buttons or other types of locks or hatches.

According to a third aspect of the invention, it is provided a method for manufacturing a booster cushion comprising a user-supporting member and side members, said method comprising the steps of:
supporting the user-supporting member by said side members;
interconnecting said side members by at least one stabilising member, thereby forming a framed construction, and;
at least partly walling said framed construction in order to form at least one compartment.

The step of supporting said user-supporting member by said side members may comprise arranging the user-supporting member so that it is held by positioning means, such as grooves or tracks, provided on the side members.

The step of interconnecting said side members using said at least one stabilising member may comprise attaching the side members to the stabilising member by fastening means, such as screws, rivets or similar. The stabilising member may also be attached to the side members by snap fit or press fit.

The user-supporting member may advantageously be a hard shell, which could be manufactured in, for example, metal or plastic.

Preferably, the shape of the shell is such that the booster cushion, in use, is lower under the seat of the user than under her/his legs, the front part of the seat, with respect to the user, being rounded to substantially follow the legs of the user.

According to fourth aspect of the invention, it is provided a method for manufacturing a combined booster cushion and bag, having a storage member and a booster cushion member comprising a user-supporting member and side members, said method comprising the steps of:
supporting the user-supporting member by said side members;
interconnecting said side members by at least one stabilising member, thereby forming a framed construction;
at least partly walling said framed construction in order to form at least one compartment, and;
joining said storage member to said booster cushion member.

The above-described method comprises the steps according to the third aspect of the invention and embodiments of said third aspect are also envisaged for this fourth aspect.

According to a fifth aspect of the invention, it is provided a storage member, for attachment to a booster cushion, wherein said storage member is configured to be releasably joined to a user-facing side of said booster cushion.

Generally, a “booster cushion” is a cushion for use in a vehicle for adjusting the position of a child or smaller person with respect to the seat belt. The storage member according to the fifth aspect of the present invention is also useful for use together with other types of seating devices, such as a cushion for use in a cinema or a resting seat for use during hiking.

The storage member according to this fifth aspect of the invention and the booster cushion according to the second aspect of the present invention are clearly inter-related products.

By “booster cushion carrying means” should be understood any means suitable for carrying a storage container. Such means can, for example, be shoulder straps, a single strap, a handle or combinations thereof being attached to the booster cushion and intended for carrying the booster cushion and/or the combined booster cushion and storage member.

Through the provision of a storage member according to the fifth aspect of the present invention, a portable booster cushion is made more useful, since it can be used for carrying additional belongings. This property makes it more likely that a user would bring along the booster cushion, together with the storage member. Hence, the safety of a child or smaller person can be enhanced.

Additionally, in the case of the booster cushion being a seating device for use while, for example, hiking, the usefulness of the seating device is increased since the storage device can be used for carrying food or other necessities and be released and removed from the seating device when time comes to take a break.

According to one embodiment of the storage member, it can further be adapted to, when joined to said booster cushion, be carried using carrying means arranged on said booster cushion.

By the “user-facing side” of the booster cushion or seating device should be understood the side which is intended for the user to sit on.

The storage member according to the invention can also comprise carrying means.

Using these storage member carrying means, which may be shoulder straps, a handle, a single strap, etc., the storage member alone or the combined storage member and booster cushion or seating device may be carried. This gives the user the possibility to decide by which carrying means the combined structure should be carried.

The storage member carrying means can further be arranged to be facing the booster cushion when said storage member is joined to said booster cushion.

By arranging the storage member carrying means, for example shoulder straps, on the side of the storage member facing the booster cushion or seating device, these carrying means are hidden when the storage member and booster cushion are attached to each other.

Naturally, the storage member can have several carrying means, such as shoulder straps and a handle. In such a case, the handle can be facing upwards and be visible, while the shoulder straps can be hidden between the two parts constituting the bag.

Preferably, the storage member can be a bag, such as a backpack. Other types of bags, such as handbags or sportsbags are naturally not excluded.

According to a sixth aspect of the present invention, it is provided a combined seating device and storage member, comprising carrying means, a storage member and a seating device member having a user-facing side, wherein said storage member is configured to be releasably joined to the user-facing side of said seating device member.

A “seating device member” according to the invention is a device to be used as a seat. It could, for example, be a cushion for use in a cinema, at a sports event or similar or it could be a resting seat for use during hiking, hunting, at a picnic or the like.

By the “user-facing side” of the seating device should be understood the side which is intended for the user to sit on.

According to an embodiment of the combined seating device and storage member said seating device member comprises at least one compartment.

According to a further embodiment of the combined seating device and storage member said carrying means are arranged on an opposite side of the seating device member as seen from the user-facing side.

Said carrying means may comprise shoulder straps, which may be adjustable in length and/or position.

Said seating device member further comprises at least one closure means, such as a lid.

### BRIEF DESCRIPTION OF THE DRAWINGS

These and other aspects of the present invention will now be described in more detail, with reference to the appended drawings showing currently preferred embodiments of the invention.

FIG. 1a is a schematic perspective view of a combined booster cushion and bag according to an embodiment of the first aspect of the present invention.

FIG. 1b is a schematic perspective view of a booster cushion member and a storage member joined together to form the combined booster cushion and bag of FIG. 1a.

FIG. 1c is a schematic view of a mechanism joining the booster cushion member and the storage member shown in FIG. 1b.

FIG. 2a is a schematic perspective view of the booster cushion member comprised in the combined booster cushion and bag in FIGS. 1a-c.

FIG. 2b is a schematic perspective view of the storage member comprised in the combined booster cushion and bag in FIGS. 1a-c.

FIG. 3a is a schematic perspective view of a framed construction comprised in a booster cushion according to a first embodiment of the second aspect of the present invention.

FIG. 3b is a schematic perspective view of the booster cushion comprising the framed construction in FIG. 3a.

FIG. 4a is a schematic perspective view of a framed construction comprised in a booster cushion according to a second embodiment of the second aspect of the present invention.

FIG. 4b is a schematic perspective view of the booster cushion comprising the framed construction in FIG. 4a.

FIG. 5a is a schematic perspective view of a storage member according to an embodiment of the fifth aspect of the present invention.

FIG. 5b is a schematic perspective view of the storage member in FIG. 5a when joined to a booster cushion.

FIG. 5c is a schematic view of a mechanism joining the storage member in FIG. 5a to a booster cushion.

### DETAILED DESCRIPTION OF PREFERRED EMBODIMENTS OF THE INVENTION

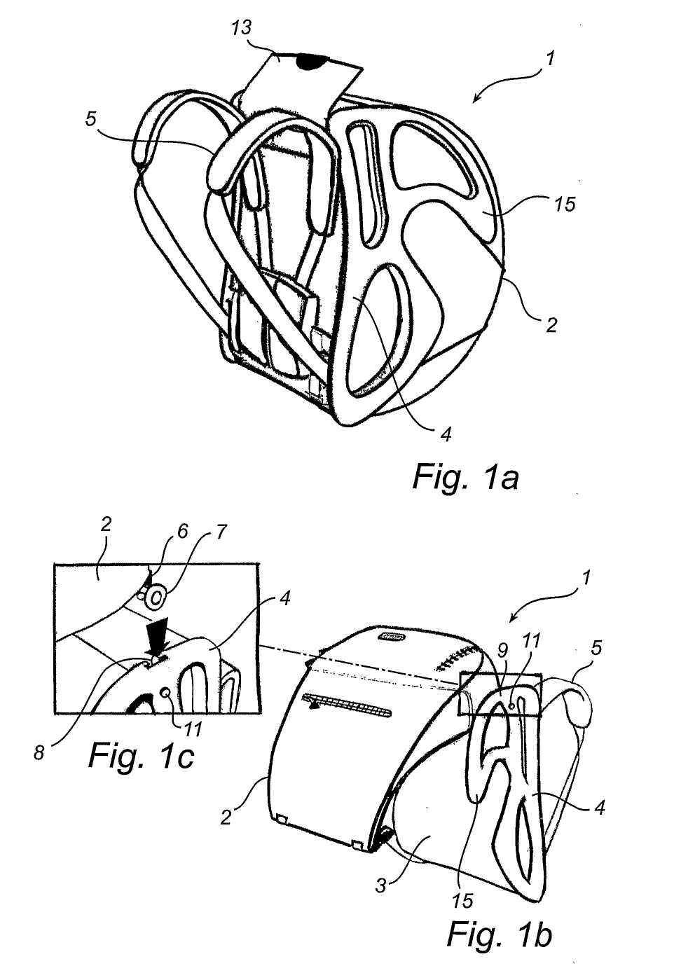

FIGS. 1a-c schematically show a combined booster cushion and bag 1 according to an embodiment of the first aspect of the invention where a storage member 2 is joined to a user-facing side 3 of a booster cushion member 4. The booster cushion member 4, is provided with carrying means 5, in the form of adjustable shoulder straps.

FIG. 1c shows an example of a mechanism, for joining the storage member 2 to the booster cushion member 4. Here, disc-shaped ends 7 of a rod 6 joined to the upper end of the storage member 2 are pushed into suitably shaped slits 8 on the upper end of the booster cushion member 4 in order to lock the two members forming the combined booster cushion and bag together. After such a hinged connection 9 has been formed at the upper end of the combined booster cushion and bag 1, the storage member is pivoted down so that a combined structure resembling a traditional backpack is formed, see FIG. 1a. In order to release or unlock the storage member 2 and the booster cushion member 4 from each other, the connection 9 is released by pushing the button 11, after which the storage member 2 can be removed and the booster cushion member 4 used to sit on in a vehicle or similar.

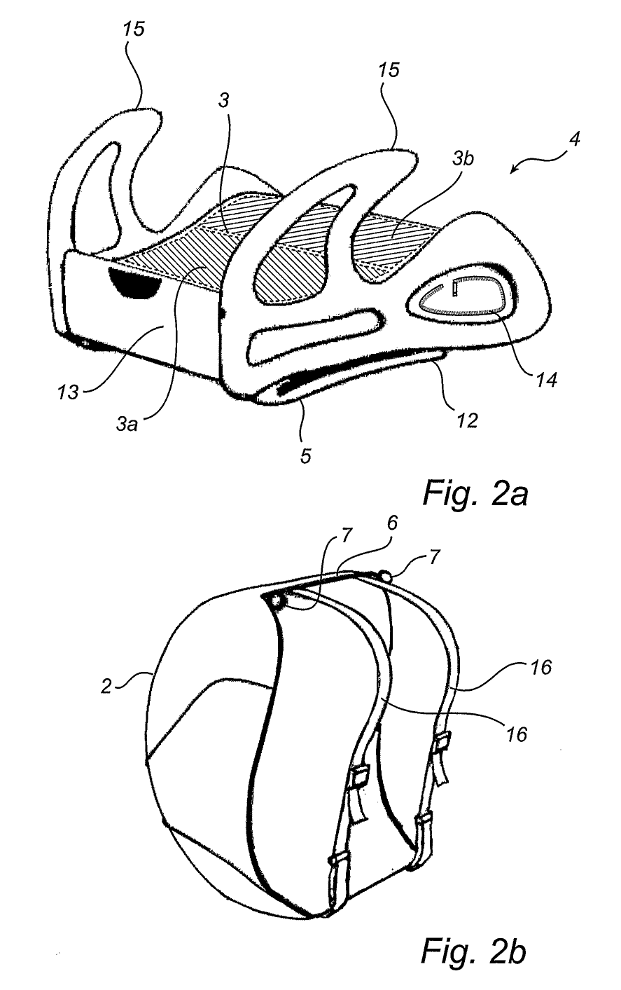

In FIG. 2a, the booster cushion member 4 is shown when detached from the combined structure 1. This booster cushion 4 has a user-facing side 3 which is formed to be lower in a first portion 3a located under the seat of a user than in a second portion 3b located under the legs of the user. Furthermore, the curvature of the second portion 3b is formed to essentially follow the curvature of the user's legs. The purpose of this seat arrangement is twofold. Firstly, the user is prevented from sliding under the seat belt in event of a collision and secondly, the booster cushion 4 is comfortable to sit on also during extended periods of time.

The booster cushion 4 in FIG. 2a also has carrying means 5, in the form of shoulder straps, which are arranged on the vehicle-facing, lower side 12 of the booster cushion member 4. These shoulder straps are conveniently out of the way when the booster cushion 4 is used in a vehicle.

Furthermore, the booster cushion in FIG. 2a has two compartments for storage of items inside the booster cushion member 4 itself. The first of these compartments is accessible through a lid 13, which is arranged in the backward-facing direction of the booster cushion 4, while the second compartment can be reached through a side-opening 14, which is here shown zipped closed.

In order to position the seat belt in a proper way for a smaller person, such as a child, the booster cushion has seat belt guides 15, which are here provided as integral parts of the booster cushion 4, but which could also be provided as separate parts attached to the booster cushion 4.

The booster cushion member 4 shown in FIG. 2a is an example of a booster cushion suitable for the combined booster cushion and bag 1 of the invention. However, practically any booster cushion fulfilling the normal safety standards could be used as a starting point for the booster cushion member included in the combined booster cushion and bag 1 of the present invention. From a performance and design point-of-view, a booster cushion based on a framed construction may be favourable, while a more traditional “shell-type” structure might be the cost-effective choice. Hence, it should be understood that different types of booster cushion member will be best suited for, for example, different market segments.

FIG. 2b shows a storage member 2, in the form of a backpack with carrying means 16, in the form of shoulder straps. At its upper end, the storage member 2 has locking means in the form of a rod 6, with disc-shaped ends 7, which are designed to interact with receiving slots on the upper end of the booster cushion member 4.

The storage member 2 according to the example in FIG. 2b has a larger storage volume than the booster cushion member 4 shown in FIG. 2a and is intended to function as the major part of, for example, a school bag. The storage space in the booster cushion member 4 could be reserved for, for example, fragile items. In other embodiments of the invention, the main storage space may be the compartment(s) comprised in the booster cushion member 4. This may be the case when the combined booster cushion and bag is a handbag. In that case, the carrying means may obviously be a single strap and/or a handle rather than shoulder straps.

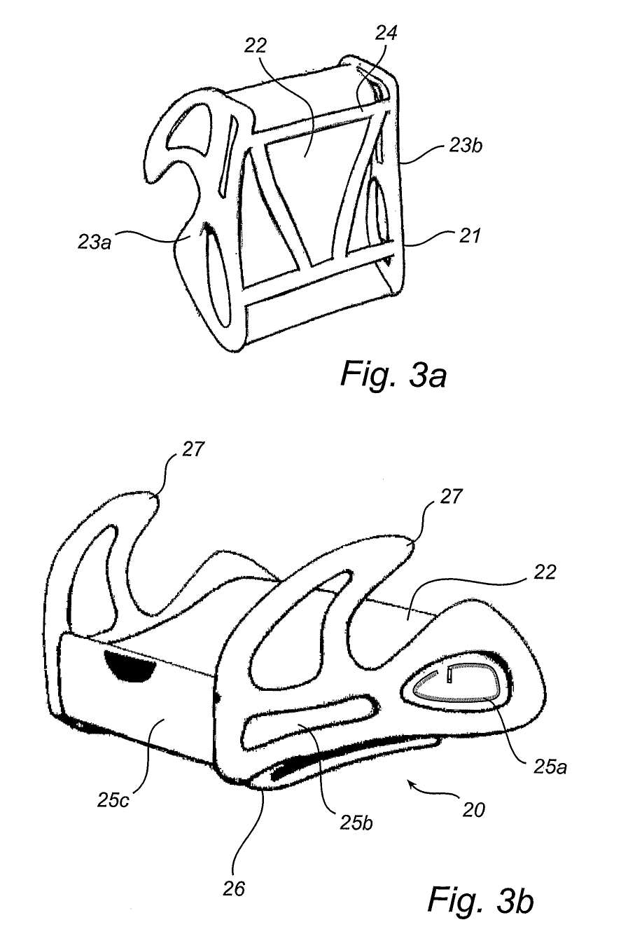

In FIGS. 3a-b a booster cushion 20 according to a first embodiment of a second aspect of the invention and a framed construction 21, comprised in such a booster cushion 20 are schematically shown. The framed construction 21 in FIG. 3a is formed by a user-supporting member 22, here in the form of a hard shell, two side-members 23a, 23b, and a stabilising member 24 in the form of a carrying frame. The carrying frame may also be separated from the stabilising member(s) and may be attached to any part of the booster cushion member. The side members 23a, 23b, support the user-supporting shell 22 and are interconnected by the stabilising member 24. This framed construction 21 can be made very light and strong. Furthermore, it can be designed in an attractive way and the realisation of an ergonomically advantageous carrying system is facilitated.

The framed construction shown in FIG. 3a is preferably manufactured in parts and assembled. According to an example of a manufacturing method, the upper shell 22 is manufactured in metal, such as steel or aluminium, and the side members 23a, 23b and the stabilising member are injection moulded in a suitable plastic material, such as ABS. The side member 23a, 23b are made with grooves following the profile of the upper shell 22 and openings for the stabilising member. At assembly, the side members 23a, 23b are properly aligned with the upper shell 22 and the stabilising member 24, respectively and, subsequently, pressed together. In this process, the side members are locked to the upper shell and the stabilising member and a strong framed construction is formed. As mentioned earlier, the carrying frame may be a part of the stabilising member(s) or subsequently attached.

In FIG. 3b, the finished booster cushion 20, comprising the framed construction 21 in FIG. 3a is shown. The framed construction 21 is here walled by fabric. The openings in the framed construction 21 are thus closed by walls 25a-c and other walls not visible in the FIG. 3b. According to the example of a booster cushion shown in FIG. 3b, one of these walls 25a may be zipped open in order to reach a compartment inside the booster cushion 20, while another wall 25c is arranged as a lid, whereby another compartment inside the booster cushion 20 can be accessed.

As is also shown in FIG. 3b, the booster cushion according to the first embodiment of the second aspect of the invention is also provided with carrying means 26, in the form of shoulder straps and seat-belt guides 27.

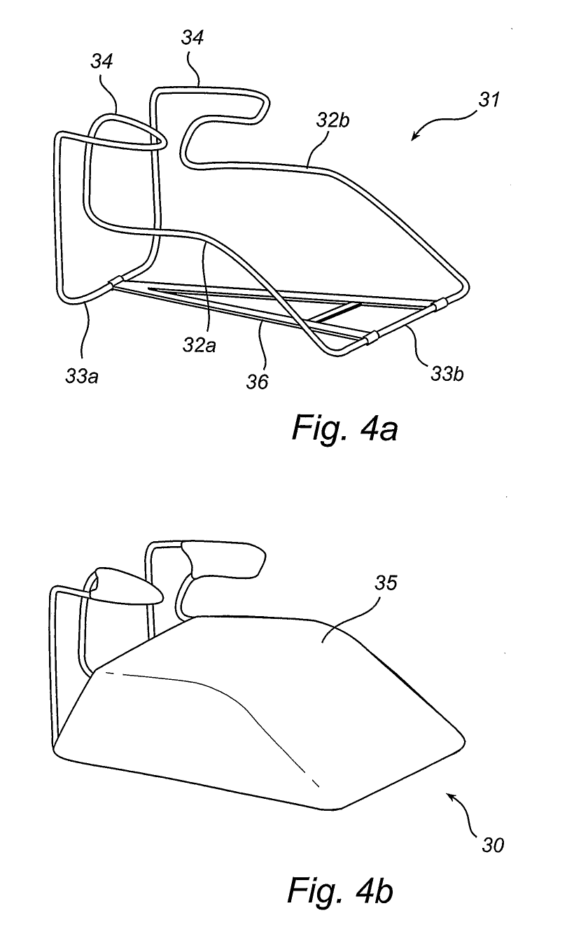

In FIGS. 4a-b a booster cushion 30 according to a second embodiment of the second aspect of the present invention is shown together with a framed construction 31 comprised in the booster cushion 30.

The framed construction 31 schematically shown in FIG. 4a is formed by side members 32a, 32b and stabilising members 33a, 33b. According to this example, the side members 32a, 32b, the stabilising members 33a, 33b and the seat belt guides 34 are all formed by one stainless steel rod which is bent in the shape shown in FIG. 4a. The seat belt guides 34 are here part of the side members 32a, 32b. Furthermore a carrying frame 36 is attached to the stabilising members 33a, 33b. Of course, the same framed construction 31 can be realised through properly attaching rod elements to each other.

In the booster cushion 30 shown in FIG. 4b, the framed construction 31 has been walled by fabric. In order to increase stability, the user-supporting member 35 is reinforced by slats (not shown) extending between the side members 32a, 32b.

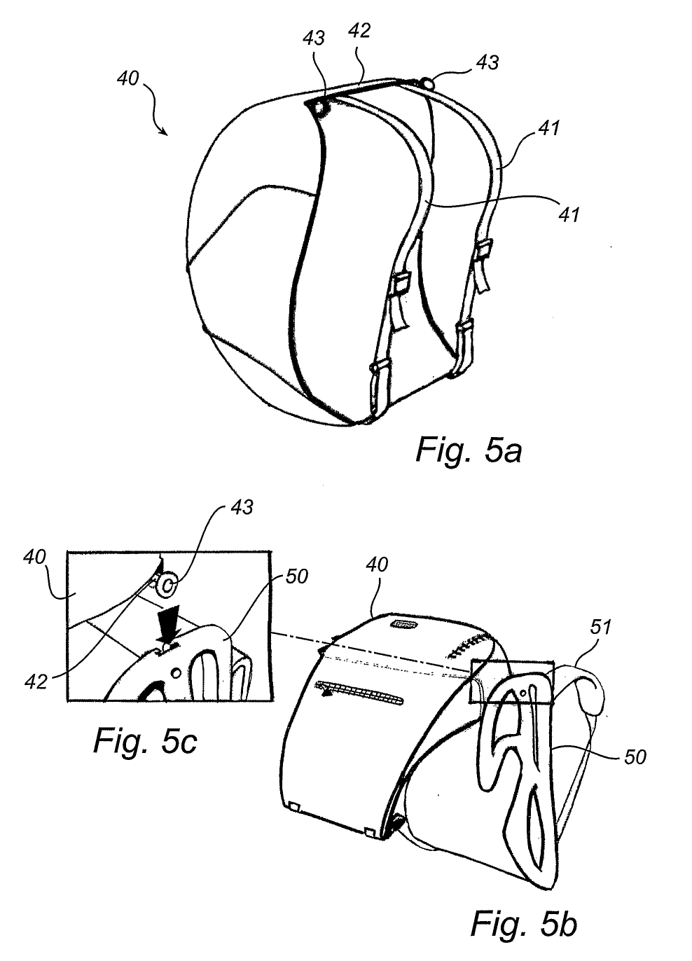

FIG. 5a shows a storage member 40 according to an embodiment of the fifth aspect of the invention. The storage member 40 is equipped with carrying means 41 in the form of shoulder straps and thus functions as a stand-alone backpack, when not joined to a booster cushion. The storage member 40 has joining means, in the form of a rod 42 with disc-shaped ends 43, which is attached to the upper end of the storage member 40.

As shown in FIGS. 5b-c, the storage member 40 is configured to be releasably joined to a booster cushion member 50. The booster cushion member typically has carrying means 51, here in the form of shoulder straps, and the storage member 40 is adapted to be carried using these carrying means 51, when attached to the booster cushion.

The person skilled in the art realises that the present invention by no means is limited to the preferred embodiments described above. On the contrary, many modifications and variations are possible within the scope of the appended claims. For example, the storage member according to the invention can be any kind of a storage container and not necessarily a backpack. The same is, of course, valid for the combined booster cushion and bag of the invention. In the above examples of embodiments, a booster cushion is referred to as an illustrative example. However, other forms of seating devices, such as a seat for use at a cinema, sports event or similar or an outdoor seat for use when hiking, hunting etc., are within the scope of the invention.

1. A combined booster cushion and bag, comprising carrying means, a storage member and a booster cushion member having a user-facing side, wherein said storage member is configured to be releasably joined to the user-facing side of said booster cushion member.

2. A combined booster cushion and bag according to claim 1, wherein said booster cushion member comprises at least one compartment.

3. A combined booster cushion and bag according to claim 1, wherein said carrying means are arranged on a vehicle seat-facing side of the booster cushion member.

4. A combined booster cushion and bag according to claim 1, wherein said carrying means comprise shoulder straps.

5. A combined booster cushion and bag according to claim 1, wherein said booster cushion member further comprises seat belt guides.

6. A combined booster cushion and bag according to claim 1, wherein said booster cushion member further comprises closure means.

7. A combined booster cushion and bag according to claim 6, wherein said closure means are positioned on at least one of the backward and sideways facing sides of the booster cushion member.

8. A combined booster cushion and bag according to claim 1, wherein said storage member comprises carrying means.

9. A combined booster cushion and bag according to claim 1, wherein said storage member is a bag, such as a backpack.

10. A booster cushion, comprising a user-supporting member, said user-supporting member being supported by side members which are interconnected by at least one stabilising member at least partly positioned below and distanced from said user-supporting member, said side members and at least one stabilising member forming a framed construction which is at least partly walled, in order to form at least one compartment.

11. A booster cushion according to claim 10, further comprising carrying means.

12. A booster cushion according to claim 10, wherein said at least one stabilising member comprises at least one strut, extending between said side members.

13. A booster cushion according to claim 11, wherein said carrying means are arranged on said at least one stabilising member.

14. A booster cushion according to claim 11, wherein said carrying means comprise shoulder straps.

15. A booster cushion according to claim 10, wherein said side members comprise seat belt guides.

16. A booster cushion according to claim 10, further comprising closure means.

17. A booster cushion according to claim 16, wherein said closure means are positioned on a backward facing side of the booster cushion.

18. A booster cushion according to claim 10, wherein the framed construction is at least partly walled by fabric.

19. A booster cushion according to claim 10, wherein the framed construction is at least partly manufactured using injection-moulding.

20. A booster cushion according to claim 10, wherein said user-supporting member is formed to be lower under the seat of a user than under her/his legs and to have a curvature substantially following the curvature of the user's legs.

21. A bag comprising a storage member and a booster cushion according to claim 10.

22. A bag according to claim 21, wherein said storage member is releasably joined to said booster cushion.

23. A bag according to claim 21 or 22, wherein said storage member comprises carrying means.

24. A storage member, for attachment to a booster cushion, wherein said storage member is configured to be releasably joined to a user-facing side of said booster cushion.

25. A storage member according to claim 24, wherein said storage member is further adapted to, when joined to said booster cushion, be carried using carrying means arranged on said booster cushion.

26. A storage member according to claim 24, wherein said storage member further comprises storage member carrying means.

27. A storage member according to 24, wherein said storage member carrying means are arranged to be facing the booster cushion when said storage member is joined to said booster cushion.

28. A storage member according to claim 24, wherein said storage member is a bag, such as a backpack.
